(19) United States
(12) Patent Application Publication
(10) Pub. No.: US 2024/0104359 A1
(43) Pub. Date: Mar. 28, 2024

(54) DISTRIBUTED NEURAL NETWORK

(71) Applicant: SAP SE, Walldorf (DE)

(72) Inventor: Arnd vom Hofe, Mannheim (DE)

(73) Assignee: SAP SE, Walldorf (DE)

(21) Appl. No.: 17/954,056

(22) Filed: Sep. 27, 2022

(51) Int. Cl. G06N 3/063

(52) U.S. Cl. CPC G06N 3/063

(57) ABSTRACT

The present disclosure provides techniques and solutions for defining, deploying, or using distributed neural networks. A distributed neural network includes a plurality of computing elements, which can include Internet of things (IOT) devices, other types of computing devices, or a combination thereof. At least one neuron of a neural network is implemented, for a given data processing request using the distributed neural network, on a single computing element. Disclosed techniques can manage data processing requests in the event of an unreachable computing element, such as by processing the request without the participation of such computing element. Disclosed techniques also include redefining distributed neural networks to replace an unreachable computing element. Information to configure computing elements as neurons can include one or more of definitions of computing elements that will provide input, weights to be associated with inputs, definitions of computing elements to receive output, or an activation function.

### FIELD

The present disclosure generally relates to neural networks. Particular embodiments provide a distributed neural network where at least two neurons of a neural network are implemented on different computing elements.

### BACKGROUND

Machine learning is becoming an increasingly popular approach for dealing with a variety of computing problems. While machine learning, like many technologies, started out largely as an area of academic interest, machine learning techniques are being packaged in a way that makes it easier for them to be used in “practical” applications.

Various issues can arise in implementing practical applications of machine learning techniques. Often, machine learning models are trained using a set of training data on a particular computing system, and inference results are generated by the same system. Machine learning applications can thus have various implementation bottlenecks, such as the availability of a suitable computing system for training machine learning models and then making practical use of the trained models using inference data. Another issue that can arise is if a computing system that is to provide an inference result is unavailable, such as if the computing system experienced a hardware or software error, or was busy processing other requests. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure provides techniques and solutions for defining, deploying, or using distributed neural networks. A distributed neural network includes a plurality of computing elements, which can include Internet of things (IOT) devices, other types of computing devices, or a combination thereof. At least one neuron of a neural network is implemented, for a given data processing request using the distributed neural network, on a single computing element. Disclosed techniques can manage data processing requests in the event of an unreachable computing element, such as by processing the request without the participation of such computing element. Disclosed techniques also include redefining distributed neural networks to replace an unreachable computing element. Information to configure computing elements as neurons can include one or more of definitions of computing elements that will provide input, weights to be associated with inputs, definitions of computing elements to receive output, or an activation function.

In one aspect, the present disclosure provides for creating a distributed neural network comprising a plurality of computing elements. A neural network definition is received of a neural network. The neural network includes a plurality of neurons. A first computing element is assigned to function as a first neuron of the plurality of neurons. A second computing element is assigned to function as a second neuron of the plurality of neurons.

First neuron information is sent to the first computing element. The first neuron information includes a definition of at least one neuron of the neural network to which output of the first neuron should be sent. Second neuron information is sent to the second computing element. The second neuron information includes a definition of at least one neuron of the neural network from which the second neuron receives input, a weight to be applied to the input, and an activation function.

In another aspect, the present disclosure provides for processing a portion of a data processing request to a distributed neural network by a computing element that implements at least one neuron of the distributed neural network along with a plurality of other computing elements that implement other neurons of the distributed neural network. First computing element neuron information is received. The first computing element neuron information includes a definition of a first plurality of computing elements of the distributed neural network from which the first computing element will receive input, a definition of a weights to be applied to input from respective computing elements of the first plurality of computing elements; an activation function to be evaluated using weighted inputs of the first plurality of computing elements to provide a result, and a definition of at least one computing element of the distributed neural network to which the first computing element provides output.

Input from at least a portion of the first plurality of computing elements is received. Respective weights are applied to respective inputs of the at least a portion of the first plurality of computing elements to provide a value. It is determined that the value should be propagated to the second plurality of computing elements. The value is sent to the at least one computing element.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 is a diagram illustrating an example configuration of a neural network.

FIG. 2 is a diagram illustrating an example distributed neural network according to the present disclosure, wherein Internet of things (IOT) devices perform the functions of neurons in a neural network.

FIG. 3 is an example computing environment in which distributed neural networks can be implemented.

FIGS. 4A and 4B illustrate scenarios where computing elements can be assigned to function as neurons in zero or more neural networks, and where multiple computing elements can be assigned the function of a particular neuron in a particular neural network, where a single such computing element is used in a given data processing request.

FIGS. 5A and 5B illustrate how a distributed neural network can be redefined to account for the unavailability of a computing element that functions as a neuron in the distributed neural network.

FIG. 6 provides examples of data that can be stored regarding neural networks, networks of computing elements that implement a distributed version of a neural network, and computing elements.

FIG. 7 is a flowchart of an example technique for creating a distributed neural network using at least two computing elements.

FIG. 8 is a flowchart of an example technique for executing data processing requests using a particular computing element serving as a particular neuron of a distributed neural network.

FIG. 9 is a diagram of an example computing system in which some described embodiments can be implemented.

FIG. 10 is an example cloud computing environment that can be used in conjunction with the technologies described herein.

### DETAILED DESCRIPTION

### Example 1—Overview

Machine learning is becoming an increasingly popular approach for dealing with a variety of computing problems. While machine learning, like many technologies, started out largely as an area of academic interest, machine learning techniques are being packaged in a way that makes it easier for them to be used in “practical” applications.

Various issues can arise in implementing practical applications of machine learning techniques. Often, machine learning models are trained using a set of training data on a particular computing system, and inference results are generated by the same system. Machine learning applications can thus have various implementation bottlenecks, such as the availability of a suitable computing system for training machine learning models and then making practical use of the trained models using inference data. Another issue that can arise is if a computing system that is to provide an inference result is unavailable, such as if the computing system experienced a hardware or software error, or was busy processing other requests. Accordingly, room for improvement exists.

The present application provides for distributed computing systems for machine learning applications. More particularly, disclosed technologies relate to neural network machine learning approaches where a machine learning model involves a plurality of “neurons.” Typically, neurons can be classified as input neurons, output neurons, or neurons that are located in one or more hidden layers of a machine learning model, where the neurons of the hidden layers take input (directly or indirectly, such as from a neuron in another, “earlier,” hidden layer) from an input neuron, perform processing on the input, and provide output to one or more output neurons. While neural network-based machine learning models involve a plurality of neurons, the neurons are generally located on a single computing device or single computing system (which single computing devices of computing systems that operate in a “unitary” manner can also be referred to as “computing elements”).

Even if a computing system involves multiple computing devices, such as in a cloud computing system, the neurons are typically treated as being located on a single, unitary computing system. In other words, an application making use of a machine learning model in a such a unitary computing system does not “know” whether the model is being run entirely on a single computing device or on multiple computing devices, much less “understand” how particular portions of the model might be run on different computing devices.

Generally, the present disclosure relates to the processing of inference requests (also referred to as “data processing requests”) where a computing element has been assigned the role of one or more particular neurons in a neural network, and where the neurons of the network are assigned to a plurality of computing elements. Some implementations specifically have neurons in one or more hidden layers of a neural network distributed to multiple computing elements. While in some cases a single computing element can be assigned the functions of multiple nodes, at any given time, the functions of a single neuron are assigned to a single computing device. In more particular implementations, each computing element is assigned the role of a single neuron in a machine learning model. In other particular implementations, all of the nodes in a neural network correspond to Internet of Things (IOT) devices, while in other implementations at least all of the nodes of one or more hidden layers in a machine learning model correspond to (discrete) IOT devices.

Assigning the role of one or more particular neurons to a particular computing element, such as a particular IOT device, can provide a number of benefits. One benefit of assigning the role of a particular neuron to a particular computing element is that machine learning tasks can continue to be performed if that computing element is not available, such as if the computing element is overloaded, is not reachable by a communication connection, or the computing element has encountered a hardware or software problem that prevents it from completing a task, or at least completing a task within desired performance parameters. In prior neural networks, since all neurons are typically implemented on a single computing element (whether a single device or a collection of multiple devices), if that computing element goes down, is unreachable, or is overloaded, the machine learning model is not available for use, which can create severe problems where machine learning is applied to practical applications where end users and commercial entities are reliant upon the machine learning model.

Since the present disclosure provides that the role of a neuron can be assigned to different, individual computing elements, the failure of a single computing device need not cause a machine learning model to be unavailable. If additional computing elements are available, they can be assigned the role of a neuron implemented by the unreachable computing element, and the machine learning model can continue to be used. Or, in some cases a machine learning model can continue to be used even if a particular computing element implementing a particular neuron fails.

In one implementation, multiple instances of a machine learning model can be generated and the neurons of which can be assigned to various computing elements. That is, for example, a given computing element can have information to be used if all computing elements that implement the neural network are available, and different information to be used if a particular computing element is unreachable. In this way, if a computing element fails or a neural network fails, the remaining computing elements can use a machine learning model that does not include a neuron or neurons of an unreachable computing element.

In other cases, the same machine learning model can continue to be used despite an unreachable computing element, but neurons of the unreachable computing element will be “ignored” for purposes of the inference result. Although a neuron missing from a model may affect the accuracy or quality of a result, a result may continue to be obtained, where thresholds can optionally be set such that results are not provided if a given confidence level is not satisfied, or if particular neurons, or a particular number of neurons, are not available. Since typical neural networks have all neurons running on a single computing element, Applicant is not aware that the concepts of recruiting computing elements to take the role of a failed neuron/computing element or if using a neural network despite a “missing” neuron have existed in the art. Even in the case of a cloud computing system being used for neural network processing, typical use cases involve deploying an entire instance of a neural network to a particular physical computing device.

As stated above, in a particular implementation, which will be discussed through the remaining of the present disclosure primarily for ease of presentation, IOT devices can be assigned the roles of neurons in a neural network. The use of IOT devices can provide a number of benefits. Many IOT devices are only active a small percentage of the time. Idle time for the IOT devices can be put to productive use by having an IOT device participate in one or more neural networks. Moreover, having an IOT device function as only a portion of a neural network, including in situations where an IOT device acts as a single neuron, can allow IOT devices to participate in neural network processing in situations where the IOT device may not have sufficient computing power to perform all of the operations in a machine learning model.

Relatedly, in at least some cases, model training is performed using a computing system other than the IOT devices, as model training can require more computational power than is needed during an inference phase after the model has been developed. While an individual IOT device may not be able to develop/train a model, and it may be at least somewhat impractical to use a network of IOT devices to develop a model, a model can be trained on other hardware and the model components deployed to suitable IOT devices, which can then perform inference tasks that are suitable for their performance parameters.

IOT devices are becoming increasingly common, and that trend is likely to accelerate. Similarly, more computationally powerful IOT devices are being introduced, including IOT devices that have a power source and an Internet connection that can be treated as constant/always on (for example, having a “hard line” power source as opposed using battery power). Thus, there is a vast pool of devices available to be used in distributed neural networks as described in the present disclosure. Device and software manufacturers can build suitable functionality into IOT devices to facilitate their being used in neural networks, which can open up new use cases for IOT device manufacturers, software providers, and end users.

Networks of IOT devices can be managed by one or more command-and-control systems. As will be further described, these command-and-control systems can be responsible for operations such as maintaining a directory of IOT devices and a directory of networks that use such IOT devices. A command-and-control system can also perform operations such as forming new networks, deploying models to device networks, and managing networks, including adjusting networks to account for devices that may have failed or otherwise be unavailable.

### Example 2—Example Neural Network

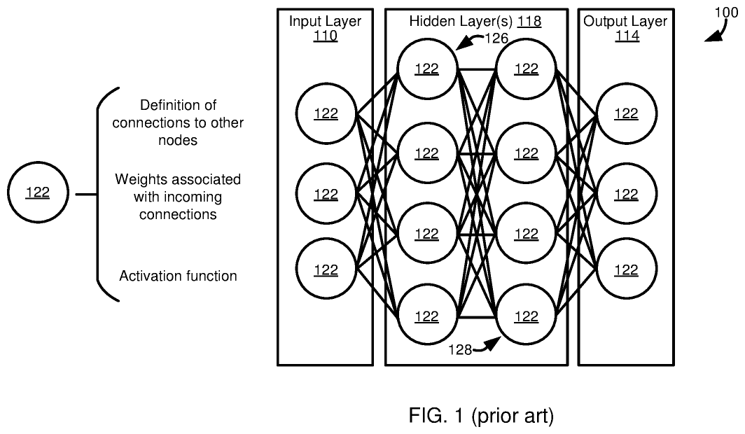

FIG. 1 illustrates a typical neural network 100. The neural network 100 includes an input layer 110 and an output layer 114, where the input layer and the output layer each include one or more nodes, or neurons, 122. The number of nodes 122 in the input layer 110 and the number of nodes in the output layer 114 are selected based on a particular machine model/use case scenario. For example, in the case of a machine learning model that provides a weather prediction, the model could include inputs such as temperature, wind speed, humidity, and measured precipitation from one or more input devices, where input devices can be, for example, at a plurality of different physical locations. Outputs of the machine learning model could include a predicted temperature at a particular location, or a predicted chance of precipitation at a particular location.

Typically, a neural network will include one or more hidden layers 118, where the hidden layer 118 is shown as including two distinct hidden layers 126, 128. Hidden layers 118 are typically included when data to be separated, or classified, must be done so in a non-linear fashion. Since neural networks are typically used to solve relatively complex problems (or, more accurately, provide a predicted solution/classification given a particular set of input), machine learning models typically include one or more hidden layers 118, where models with more than one hidden layer are often referred to as “deep learning” models.

One feature of the neural network 100 that can be seen from FIG. 1 is that all of the nodes 122 of one layer are connected to all of the nodes of the “next” layer. That is, a given node of the input layer 110 is connected to all of the nodes of the first hidden layer 126. In turn, each node of the first hidden layer 126 is connected with each node of the second hidden layer 128. In turn, each node of the second hidden layer 128 is connected to each node of the output layer 114.

Each node 122 can be associated with various properties that result in a given neural network being “trained” to solve a particular problem. That is, a neural network is typically configured with a desired configuration of nodes, including the number of nodes in each of the layers 110, 114, 118. Various processing operations can also be specified for each node 122. A set of training data is then supplied to the neural network, where weights associated with each node (or, at least those nodes that receive appropriate input from other nodes of the neural network 100) get adjusted as elements of a set of training data are processed using the neural network, a result determined by neural network is compared with an “actual” result for the training data element, and a measurement of the error between the determined result and the actual result is backpropagated through the neural network to adjust the weights associated with the various nodes 122.

In general, a given node of the hidden layer 118 or the output layer 114 includes one or both of:
(1) a set of weight to any “input” nodes, where in this case an “input” node is a node that provides input to another node, regardless of whether the “input” is from a node in the input layer 110 or a node in a layer of the hidden layer(s) 118; or
(2) an activation function that determines whether a node should “fire” (that is, be “activated”/have the node contribute to an inference result).

### Example 3—Example IOT Devices

As used herein, an “IOT device” refers to a computing element where the computing element itself is embedded within or is in communication with, another physical device. Typically, an IOT device includes one or more sensors, or is configured to receive sensor information from a sensor coupled to the physical device associated with the IOT device. While humans may perform tasks on or using an IOT device, a primary purpose of an IOT device is to act in an automated manner, such as to send sensor information, or information derived at least in part therefrom, to other IOT devices or to a central system, where often the central system will receive data from multiple IOT devices, and in some cases the central system uses data from multiple IOT devices in a single computing process/for a particular purpose.

A wide variety of IOT devices can exist, and as IOT device technology and use scenarios evolve, the differences between IOT devices and “traditional” computing devices can progressively overlap. In order to help distinguish between IOT devices and other types of computing devices, for the purposes of the present disclosure, an IOT device refers to a computing device that (1) includes a sensor to sense an analog world property (as nonlimiting examples, temperature, humidity, precipitation, radiation, actuation of a physical component); or (2) is embedded within or is in communication with, and typically in relatively close physical proximity to, a physical machine or apparatus that serves a particular purpose and, while such a machine/apparatus may have some computing capabilities, the computing capabilities are specially purposed for/limited to computing capabilities that serve the particular purpose of the physical machine.

As an example, a refrigerator may include computing functionality to monitor and control the operation of the refrigerator, and may even have user interface functionality, such as to allow a user to set the temperature of the refrigerator, set timers, display photos, make shopping lists, displays from cameras that show the interior of the refrigerator, or for controlling water/ice dispensing features. The refrigerator can also include features to communicate with other computing devices, such as allowing a user to interact with the refrigerator using a smart phone. However, the computing functionality of the refrigerator is typically limited in the sense that the refrigerator is not likely to support computing functionality that is not directly tied to features that would make the refrigerator useful to consumers—it is less likely include, or even support, a word processor, web browser, photo editing software, etc. Similarly, the ability of an end user to install or modify software operating on computing hardware of a special-purpose physical machine is also more limited, such as a either being limited to particular functionality installed by a manufacturer or selecting from a “menu” of available “apps”—in other words, a user may be allowed to customize the software/device in particular ways allowed by the manufacturer, but may not be able to install applications or, more generally, modify the computing device as a user would typically be able to do with a general purpose computing device, such as personal computer or laptop, or even somewhat more limited, but still general purpose, computing devices such as smartphones or tablet computers.

Another difference between IOT devices and more general-purposes computing devices is that, typically for both cost and space requirements, IOT devices are typically only provided with sufficient computing resources (processor, memory, secondary storage, etc.) to perform the special-purpose computing of either the embedded IOT device that is in communication with a physical machine/apparatus or a specific set of functionality, typically at least in part determined by the sensing capabilities of, a non-embedded IOT device. While certain disclosed distributed neural networks can involve individual computing elements functioning as neurons, in general such networks need not include any IOT devices, or can include a combination of IOT devices and non-IOT devices. However, specific disclosed embodiments allow an entire neural network to be generated using IOT devices.

An example structure/configuration of an IOT device that can be used in embodiments of the present disclosure is further described in Example 4. Generally, an IOT device can include software that facilitates that IOT device participating in distributed neural networks.

### Example 4—Example Distributed Neural Network Implemented by IOT Devices

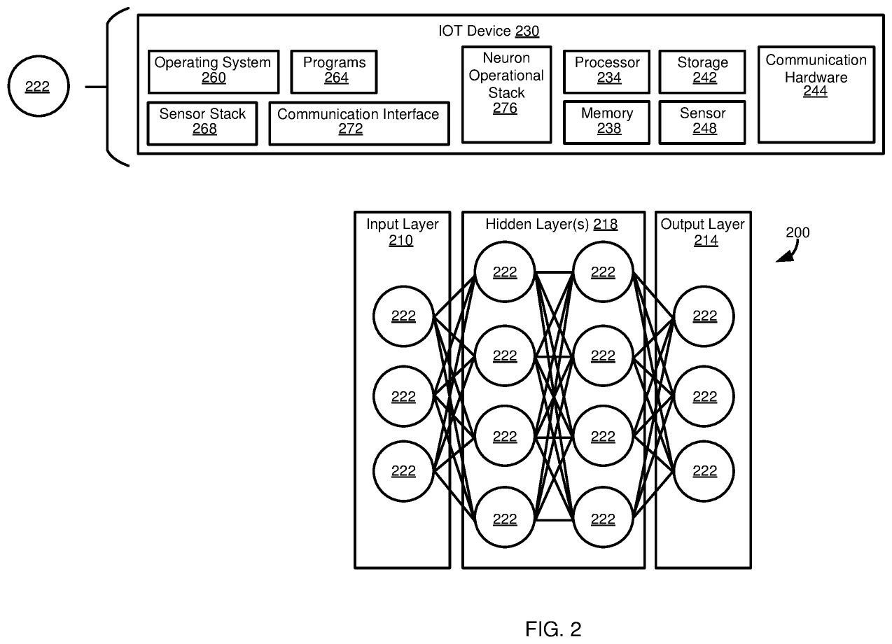

FIG. 2 generally illustrates a distributed neural network 200 according to the present disclosure. The neural network 200 is generally similar to the neural network 100 of FIG. 1, in that it includes an input layer 210, an output layer 214, and one or more hidden layers 218, where the various layers include one or more neurons 222. As with the network 100, the particular number and arrangement of neurons 222 shown in the network 200 is for illustrative purposes only, and in practice the network can vary in the number of neurons in a particular layer, the number of layers included in the hidden layer 218, and the connections between neurons of the various layers of a neural network.

The neural network 200 differs from the neural network 100, in that, as has been described, the neural network 100 is typically implemented on a single computing element. In contrast, the neural network 200 is implemented using a plurality of computing elements. As shown, each neuron 222 corresponds to an IOT device 230. However, particular embodiments of the present disclosure include distributed neural networks where all or a portion of the neurons 222 are implemented on computing elements other than IOT devices. Similarly, particular embodiments of the present disclosure include distributed neural networks where a computing element, which can be an IOT device 230 (such as described in Example 3), implements multiple neurons, provided that the neural network includes multiple, discrete computing devices that implement the neurons 222. More particularly, the present disclosure includes neural networks 200 where a given neuron 222 of the neural network is implemented for a given instance of the neural network, at a given time, on a single computing element.

FIG. 2 illustrates components of an example IOT device 230. The IOT device 230 includes both hardware and software, as shown. However, IOT devices 230 can include computing devices where functionality described as being implemented in software is implemented at the hardware level, such as being implemented in an application specific integrated circuit (ASIC) or using a field programmable gate array (FPGA).

As to hardware, the IOT device 230 includes or more hardware processors 234 (which can be in turn operate additional processors in the form of virtual processors), memory 238 (e.g., RAM), storage 242 (i.e., persistent storage, such as ROM, EPROM, EEPROM, flash memory, disk-based storage, etc.), communication hardware 244 (e.g., Bluetooth, IR, WIFI, ethernet, NFC, etc.), and optionally one or more sensors 248 (e.g., temperature sensors, humidity sensors, sensors to detect actuation of a physical component, radiation sensors, sensors to detect chemical components, etc.).

The IOT device 230 can include various types of software, or software-like features that are implemented in whole or part in hardware. In some cases, the IOT device 230 includes an operating system 260. The operating system 260 can perform operations similar to operating systems for more general-purpose computing devices (desktop computers, laptops, tablets, smartphones, etc.), but is typically more lightweight given the more limited functionality (and computing resources) of the IOT device. Without limiting the scope of the present disclosure, examples of operating systems 260 that can be used in an IOT device 230 include Contiki (open source), freeRTOS (open source), MBED OS (open source, ARM, Limited, Cambridge, England), MICROPYTHON (George Robotics Ltd., Cambridge, England), embedded LINUX (Linux Foundation, San Francisco, CA), RIOT (open source), TINYOS (open source), WINDOWS 10 IOT (Microsoft Corp., Redmond, WA), OPENWRT (open source), RASBIAN PI (open source), UBUNTU CORE (Canonical Ltd., London, England), UBUNTU MATE (open source), RISC OS OPEN (open source), RISC OS PI (open source), TIZEN (Linux Foundation, San Francisco, CA), ELINUX OS (open source), LIBREELEC (open source), VXWORKS (Wind River Corp., Alameda, CA), MICROEJ (MicroEJ, Pays de la Loire, France), THREADX (Microsoft Corp., Redmond WA), MICRIUM (Silicon Labs, Austin, TX), ZEPHYR (Linux Foundation, San Francisco, CA), NUCLEUS (Mentor Graphics, Wilsonville, OR), MONGOOSE OS (Cesanta Software Ltd., Dublin, Ireland), ANDROID THINGS (Google, LLC, Mountain View CA), SNAPPY (Canonical Ltd., London, England), and FUCHSIA (open source).

The IOT device 230 can include one or more programs 264, where the programs can be those that carry out primary functionality of the IOT device, optionally including additional functionality of a device into which the IOT device is embedded. That is, the IOT device 230 can optionally share hardware or software with other functionality for a device into which the IOT device/functionality is embedded. When the IOT device 230 includes sensors 248, or when the IOT device receives sensor data from another device, the IOT device can include a sensor software stack 268 that can be used for communicating with the sensor, processing sensor data, and sending sensor data to other components of the IOT device 230, including to one of the programs 264, to the operating system 260, or to a communication interface 272.

The communication interface 272 is responsible for transferring data generated by or received by the IOT device 230, such as formatting the data to be transmitted using one or more of components of the communication hardware 244. The communication interface 272, as well as other components (hardware or software, including the sensor 248 or the sensor stack 268), of the IOT device 230 can communicate with a neuron operational stack 276. The neuronal operational stack 276 can mediate operations of the IOT device 230 with respect to use of the IOT device in a distributed neural network. For example, the neuronal operational stack 276 can accept data processing requests and send output of data processing requests, such as to another device in a neural network of which the IOT device 230 is a member. The neural operational stack 276 can also receive information about how the IOT device 230 should operate with respect to a given neural network of which it is a member, such defining input neurons for a neuron whose operations the IOT device 230 performs, weights to be applied, input from the input neurons, an activation function to be applied to the input, and the identity of one or more computing devices that should receive output of the neuronal processing performed by the IOT device 230. In practice, when the IOT device 230 receives a data processing request, the weighting and processing can be performed by the neural operational stack 276 or one of the programs 264, where execution of the request can be mediated by the operating system 260 and then executed using hardware of the IOT device, such as using the processor 234 and the memory 238.

The format of a data processing request can vary depending on the particular implementation of the distributed neural network. In cases where the IOT device 230 serves as a single node in a single network, the data processing request can simply include the input data. In cases where the IOT device 230 serves as multiple nodes in a single network, the data processing request can include, for each input value, the input value and an identifier of the node for which the input value is to be used. In other cases, the data processing request can be in the form of a function call, where the input values are provided as function argument and the definition/implementation of the function controls the assignment of input values to nodes (and thus the application of weights, activation functions). In cases where the IOT device 230 serves as one or more nodes in each of one or more networks, the data processing requests can be generally configured as described above, except that the data processing request either identifies a particular neural network for which the input is being provided (which can be in the form of an argument to a function call) or the data processing request can identify/target a particular function that is associated with a particular neural network.

### Example 5—Example Handling of “Missing” Neurons

Typically, a sum is calculated from the weighted combination of inputs to a neuron, and the sum is provided to the activation function for the neuron to determine whether the neuron should “fire”—meaning that the output of the neuron is provided as an output to the next layer (with reference to FIG. 1, either another layer of the hidden layer(s) 118, the output layer 114, or as a result provided by a node 122 of the output layer). A loss function is used to calculate the error to be backpropagated to the network, which thus adjusts the weights of inputs to the neurons, which improves the performance of the network as the network is trained.

Note that, at least in some implementations, when a distributed neural network according to the present disclosure is “missing” a neuron because a computing element (such as an IOT device) has failed or is unavailable, the missing computing element can be equivalent to a fully available and connected neural network where a particular neuron does not pass its output forward because its activation function (given particular input) did not cause the neuron to “fire.” As mentioned, the ability to continue to provide inference results despite a failed computing element/neuron (or multiple computing elements/neurons) can provide improved resilience compared with systems where a neural network is located on a single computing element.

The use of a distributed neural network in the case of one or more neurons located on failed or unreachable computing elements can be a configurable option, including an option that can be configured by end users. The configuration can be provided for an entire neural network, or it can be specified at a more granular level, such as having a particular request indicate whether the request should be processed if one or more unreachable neurons are detected, or having requests that include an identifier for a particular user or use, wherein the identifier is associated with rules for determining whether a given request should be processed where not all neurons in the neural network are available.

Rules for determining behavior in the face of one or more missing neurons can be simple, such as that a request will or will not be processed despite one or more “missing” neurons. Rules can be more complex, such as specifying a certain number or percentage of neurons that may be unreachable such that a request will or will not be processed, or specifying a predicted or actual confidence level that is required for a request to be processed. Rules can be even more complex, including being correlated with particular properties of a particular neural network. For example, a rule can specify that requests will not be executed if a particular neuron is not reachable that has a certain level of predictive power, which in some cases can be correlated with the weight assigned to that neuron as input to a neuron in a subsequent layer (e.g., IF calculate_neuron_contribution(missing_neuron)>0.5, then doNotProcessRequest=TRUE; where the calculate_neuron_contribution function, in a particular example, determines for the missing neuron the highest weight assigned to the missing neuron by any neuron to which the missing neuron serves as input, and the request is not processed if the missing neuron provides more than 50% of the input to a subsequent neuron). Similarly, some neurons serve as input to a higher number of neurons than other neurons (typically because of the layer architecture of a particular neural network), and the number of neurons to which a missing neuron provides input can be used, in whole or part, as criteria for determining whether a request should be processed in the presence of a missing neuron.

### Example 6—Example Computing Environment for Implementing Distributed Neural Networks

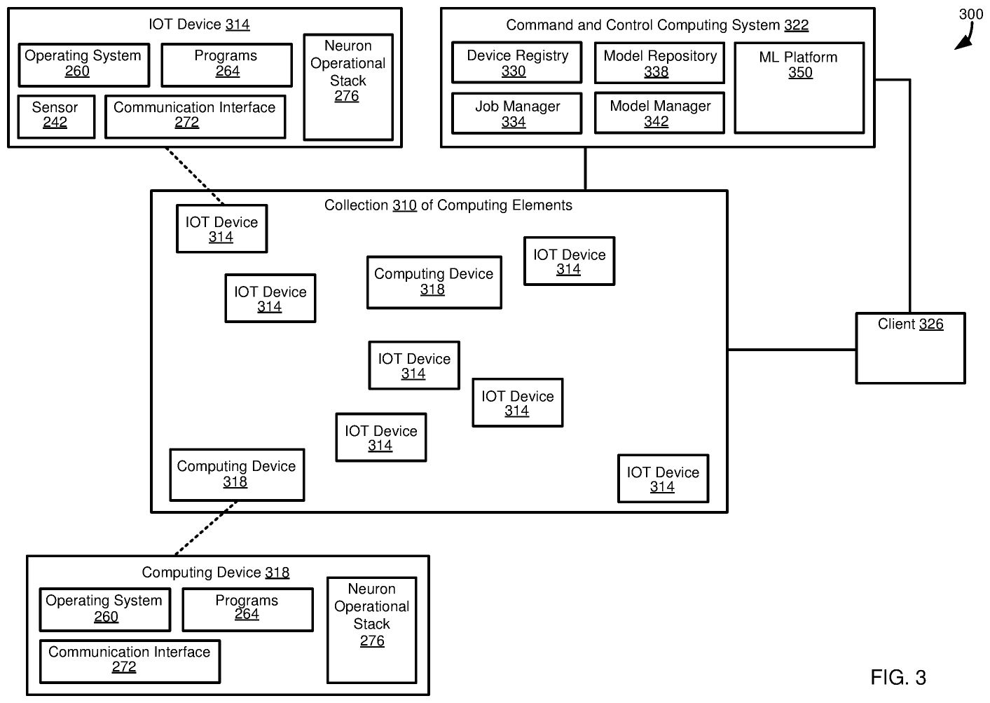

FIG. 3 illustrates an example computing environment 300 having a collection 310 of computing elements that can participate in one or more distributed neural networks according to an aspect of the present disclosure. Computing elements of the collection 310 of computing elements can be IOT devices 314 (which can include the elements of an IOT device as described in conjunction with FIG. 2, where such components are correspondingly labelled in FIG. 3 for an example IOT device 314) or non-IOT computing devices (or computing systems) 318. As has been described, according to various implementations of the present disclosure, a particular distributed neural network formed from the collection 310 of computing elements includes only IOT devices 314, only non-IOT computing devices 318, or includes a combination of one or more IOT devices 314 and one or more non-IOT computing devices 318. Similarly, the collection 310 itself can include only IOT devices 314, only non-IOT computing devices 318, or a combination of IOT devices and non-IOT computing devices.

Computing elements of the collection 310 of computing elements can communicate with each other, as well as with one or more command-and-control computing systems 322. Computing elements of the collection 310 of computing elements typically function as hidden nodes (or neurons—unless otherwise indicated the terms nodes and neurons can be used interchangeably in the context of a neural network) in a neural network, and computing elements may in some cases serve as input nodes or output nodes. Thus, communications between computing elements in the collection 310 of computing elements can include communications from a computing element serving an input node to a computing element serving as a hidden layer node, communications between hidden layer nodes, or communications between a hidden layer node and one or more output nodes. Communications can be performed using any suitable protocol and using any suitable transmission medium, including wired or wireless communication media. In a particular example, the transmission protocol is TCP/IP.

Communications between a command-and-control computing system 322 and computing elements of the collection 310 of computing elements can similarly use any suitable transmission medium or protocol, including using TCP/IP over a wireless transmission media. The communications can serve a variety of purposes. In some cases, the command-and-control system 322 provides input values to the computing elements of the collection 310 of computing elements, either input in the form of input values to input nodes of the distributed neural network, or as communications from input nodes of the command-and-control system 322 (or sent to the command-and-control system from another source to be forwarded to the distributed neural network) to hidden layer nodes of the distributed neural network. Similarly, communications from computing elements of the collection 310 of computing elements can include communications from hidden layer nodes of the collection of computing elements to output nodes of the command-and-control computing system 322 (or where the command-and-control computing system forwards such communications to output nodes at another location), or communications from output nodes of the collection of computing elements and a control computing system.

When the command-and-control computing system 322 receives data from output nodes of the collection 310 of computing elements, the command-and-control computing system 322 can optionally process the output (such as to take a particular action or calculate a particular result), or can forward the output to another computing system that takes such action. That is, the command-and-control computing system 322 can be accessed by one or more client computing devices 326, where the operation of a client computing device will be described in further detail below.

Communications between the command-and-control computing system 322 and the computing elements of the collection 310 of computing elements can also relate to the configuration and management of neural networks. Computing elements can be registered as being part of the collection 310 of computing elements. At any given time, a given computing element can be unavailable (whether assigned to one or more neural networks or not), available but unassigned to a neural network, or available and assigned to one or more neural networks. Computing elements can be periodically polled to determine their status (available or not), or computing elements can periodically send messages to a command-and-control computing system 322 to indicate that the computing element is still available (where, if a message is not received, such as within a particular timeframe, the command-and-control computing system assumes that the given computing element is not available).

When a neural network is created, the command-and-control computing system 322 can assign computing elements of the collection 310 of computing elements to serve as neurons. Selection of computing elements to serve as neurons in a given neural network can be based one or more of a number of possible considerations, including a number of neural networks to which a given computing element is already assigned, an expected amount of processing to be performed by the computing element in its functioning as a node (including in view of expected amounts of processing associated with any other neural networks of which the computing element is a member—in other words the available capacity of a computing element can be considered), an expected processing complexity (for example, a number of input nodes from which the computing element will receive communications, a number of output nodes to which the computing element will send communications, a complexity of an activation function to be assigned to a node, or a complexity of backpropagation data to be processed by the node (if the neural network might undergo additional training/optimization beyond its initial training)).

The consideration of processing complexity can take in account the available computing resources of a given computing element, both in terms of absolute computing resource (such as processor type, amount of memory, networking capabilities) and in terms of an available amount of such computing resources (which can consider both a percentage of such computing resources which are desired to be “reserved” for core functionality of the computing element, such as for a current intended purpose of an IOT device 314). As for available amounts of computing resources, in some cases a command-and-control computing system 322, such as in response to instructions from a client computing device 326, can specify an amount of computing resources that should be reserved for “core” functionality of the computing element, or which should be made available to a particular neural network, or for neural network processing, generally.

In particular implementations, computing elements can be assigned quantitative values that describe the available computing resources of a computing element or a qualitative description of such computing resources. For instance, a computing element can be classified as having a “high,” “medium,” or “low” amount of computing resources, and this classification can be used in assigning computing elements to a neural network. For example, a computing element may not be assigned to a neural network that has a higher node processing requirement than the computing element (that is, a “low” computing capacity computing element would not be assigned to a neural network that preferably uses “high” or “medium” capacity computing elements), at least if computing elements are available that meet or exceed the desired computing requirements for a neural network.

The command-and-control computing system 322 can also be used to monitor the availability of computing elements and to take action if a computing element assigned to one or more neural networks becomes unavailable. That is, if such a computing element is detected, the command-and-control computing system 322 can attempt to replace the unavailable computing element with a computing element that is available. In some cases, the command-and-control computing system 322 takes this action in response to determining that a computing element is unavailable. In other cases, the command-and-control computing system 322 waits to reconfigure computing elements until a data processing request is received that involves a neural network involving the unreachable computing element. Waiting for a request to reconfigure a neural network can be beneficial in some cases, as it can avoid expending processing resources on network reconfiguration in the event that the computing element becomes available again before a processing request is received.

The time at which a neural network is reconfigured can itself be a configurable property. For example, some neural networks may be involved in tasks that are more critical, and are thus less tolerant of results not being available, or results being delayed. Such neural networks can be configured to be “repaired” upon the detection of a failed computing element, while neural networks that are more tolerant of processing delays can be configured to be “repaired” only upon the receipt of a processing request involving the network.

More complex rules can be used to determine when or if a neural network should be repaired. As has been described, the assignment of different neurons in a neural network to different computing devices provides a paradigm where it is possible for a neuron to be “unavailable,” which can be treated as if the activation function of the neuron did not provide a value that caused the neuron to fire. If a neural network provides a reasonable answer in the absence of one or more unavailable neurons, including if a particular unavailable neuron contributes less than a certain amount to a result or is connected to less than a threshold number of other neurons, neural network repair can either be postponed or ignored (at least if/until the status of computing elements in the network causes a different result to be obtained).

The command-and-control computing system 322 can include a variety of components to implement management of neural networks formed from the collection 310 of computing elements. The command-and-control computing system 322 can include a device registry 330. The device registry 330 can store information about computing elements in the collection 310, such as their status, computing capabilities (including whether a computing element is currently executing any tasks), and assignment to neural networks.

The command-and-control system 322 can also include a job manager 334. The job manager 334 can be responsible for receiving data processing requests, such as from a client computing device 326, and sending results in response to such request. That is, the job manager 334 can receive data values to be processed and submit those to the input nodes of the collection 310. Or, the job manager 334 can include the input nodes and can forward output of the input nodes to other nodes of the neural network that are included in the collection (such as hidden layer nodes). The job manager 334 can also be responsible for communicating the job to relevant computing elements of the collection 310 of computing elements and receiving processing results from computing elements of the collection. The job manager 334 can also monitor job execution, such as to determine if a job is not completing within an expected timeframe.

In other cases, the command-and-control computing system 322 is not directly involved in submitting data processing requests to a distributed neural network, or receiving results therefrom. For example, the client 326 can send input values to input nodes of the collection 310, or the client can have input nodes and can send the output of such nodes to other nodes of the collection (such as hidden layer nodes). In such cases, the command-and-control computing system 322 is used to create, deploy, and maintain distributed neural networks, while data processing requests can be submitted by other computing systems or devices, such as by a client device 326. A distributed neural network can be configured to send output as directed, such as to a client device 326 submitting a data processing request.

Note that a “data processing” request can be manual or automatic. For example, a client 326 can manually send input data to be processed by a neural network, or input data can be automatically sent upon a triggering event (such as when facial image data is received through a biometric-controlled access procedure). At least certain “manual” or “automatic” processes can be thought of as “always on,” such as if a temperature sensor of an IOT device triggers use of the neural network whenever a new reading is made, or according to a defined period/schedule. In an “always on” scenario, a neural network can be left in an instantiated state, so it can immediately process input when received, either through an automated or manual process. Otherwise, a neural network can be defined, but is instantiated when a request is received, and may be de-instantiated afterwards.

Similarly, the command-and-control computing system 322 can send a client device 326 information about a configured distributed neural network, such as the identities of one or more computing elements that should receive input for data processing requests, and in the case where different inputs are provided, information about which particular inputs should be sent to which particular computing elements of the distributed neural network. Optionally, the command-and-control computing system 322 can send to the client computing system 326 information needed to authenticate a data processing request, or such information can be provided by a client computing system in a request to generate a distributed neural network and this information can be configured for the distributed neural network by the command-and-control computing system 322.

It has been described that an aspect of the present disclosure involves different computing elements serving as different nodes in a given neural network, as opposed to having all nodes being implemented on (or in a manner equivalent to) a single computing device. However, in some cases this aspect refers to the structure of the neural network at a given time/for a given data processing request. That is, aspects of the present disclosure can provide neuronal redundancy, in addition to/in place of the “repair” or “delay” functionality described above. In such cases, multiple computing elements can be assigned the role of a particular neuron in a particular neural network, but a single such computing element is used for any given data processing request. The functions of the job manager 334 (or optionally another component of the command-and-control computing system 322) can include determining which of multiple computing elements serving as a particular neuron should be used for a given data processing request.

In some cases, a default computing element, or a computing element determined from a priority list of computing elements, can be used by the job manager 334 when the default or higher-priority computing element is used if available, and otherwise another computing element (such a next computing element in a priority list) is used. In other cases, the selection of computing elements to be used can depend on a data processing load of a computing element. For instance, if a computing element serves as a neuron for each of multiple neural networks, and the computing element is already processing a task for a first neural network, another computing element that is not currently processing a task might be selected for a task for a second neural network, in order to help balance the processing load among the computing elements of the collection 310.

The command-and-control computing system 322 can include a model repository 338. The model repository 338 can include definitions of neural networks that can be implemented with computing elements of the collection 310. For example, the model repository 338 can store information regarding a number and type of neurons in a given neural network, how the neurons are connected, weights associated with such connections, and activation functions to be used by particular neurons. In some cases, a network definition can also include details that can be used to help select appropriate computing elements to serve as neurons in the network, such as information about an expected request frequency/processing load for the neural network, information regarding processing complexity associated with the neural network or particular nodes thereof, or information about the performance requirements of the neural network/requests relating thereto (such as a desired response time, tolerances for missing neurons, accuracy tolerances, etc.).

Models can be implemented using computing elements of the collection 310 using a model manager 342, although in other implementations this functionality can be implemented by the job manager 334 or another component of the command-and-control computing system 322. The model manager 342 can use the information in the device registry 330 and the model repository 338 to assign particular computing elements to function as neurons in a given neural network, including updating the device registry to reflect such assignment. Once a computing element has been assigned to function as the neuron, the model manager 342 can send information to the computing element to function as a neuron, including one or more of defining inputs that should be received by the computing element in its function as a particular neuron (including so that the computing element can determine when needed inputs have been received so that the computing element can process the inputs to produce an output), defining weights to be applied to inputs, setting activation function to be used, and defining where an output result should be sent. In a particular implementation, the information for configuring a computing element to function as a particular neuron can be sent from the model manager 342 to an IOT device 314, where it is processed using the neuron operational stack 276.

The command-and-control system 322 can optionally include functionality to help generate machine learning models, such as defining models or conducting training of a model. This functionality can be performed by a machine learning platform 350. The machine learning platform 350 can include a user interface to facilitate a user in defining models, and associating a model with training data. The machine learning platform 350 can also interface with other components of the command-and-control computing system 322, such as to submit processing jobs, receive (and optionally interpret) results, to request the creation/deployment of a model on the collection 310 of computing elements, or to configure execution properties of the model (such as defining processing or performance requirements). In other cases, some or all of the functionality of the machine learning platform 350 can be performed elsewhere, such as being performed by a client computing system 326.

### Example 7—Example Assignment of Neuron Functions to Computing Elements

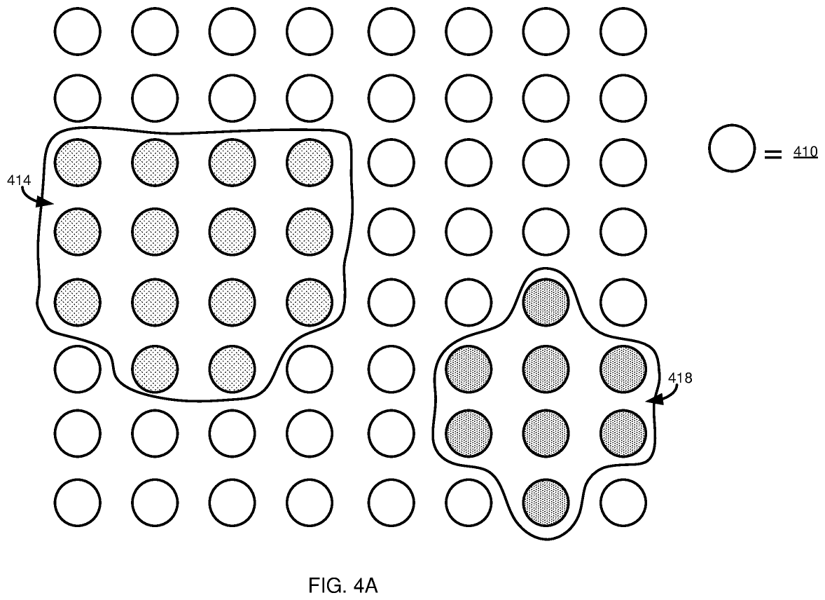

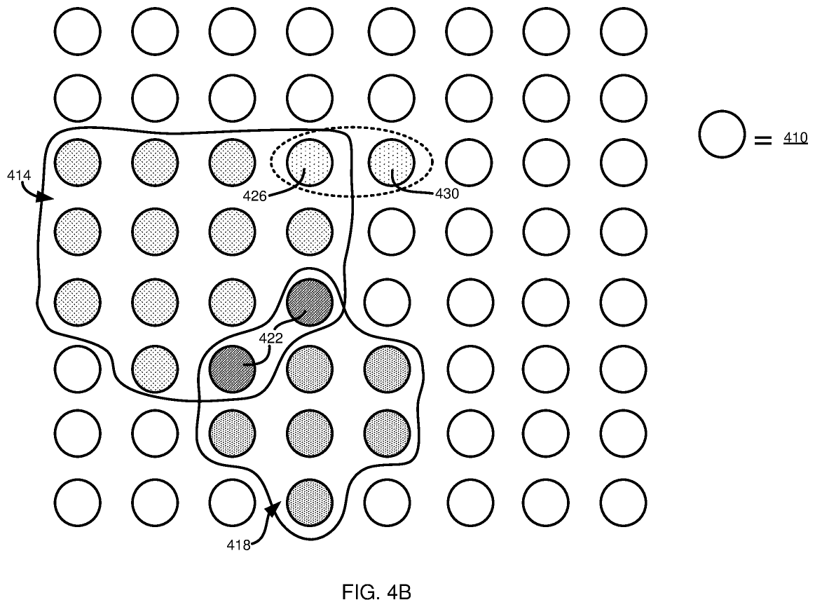

FIGS. 4A and 4B illustrate, at a high level, how computing elements (such as described with respect to FIG. 3) can be assigned to neural networks. In FIG. 4A, a plurality of computing elements 410 are present. A portion of the computing elements 410 have been assigned to act as neurons in a first neural network 414. Another portion of the computing elements 410 have been assigned to act as neurons in a second neural network 418. In this example, not all computing elements 410 have been assigned to a neural network, and each computing element has been assigned to at most a single neural network.

FIG. 4B includes the same computing elements 410 as FIG. 4A, and also includes the first and second neural networks 414, 418, but the assignment of computing elements to neural networks in FIG. 4B differs from the assignment in FIG. 4A. Of particular interest, in FIG. 4B, computing elements 422 serve as neurons in both neural networks 414, 418.

FIG. 4B also illustrates how a collection of computing elements 410 can have redundant computing elements serving as the same neuron, although a single computing element serves as the neuron for any given data processing request. In particular, the first neural network 414 includes a neuron that can be provided by computing element 426 or computing element 430. In the configuration of the first neural network 414 reflected in FIG. 4B, the computing element 426 is active as the neuron, while the computing element 430 is inactive as the neuron (although the computing element 430 could be active in other neural networks).

### Example 8—Example Reconfiguration of Distributed Neural Networks

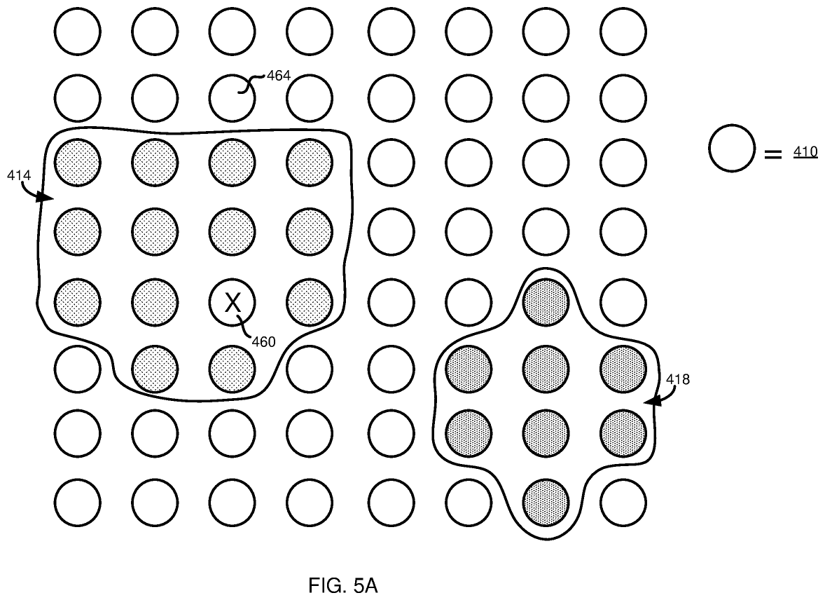

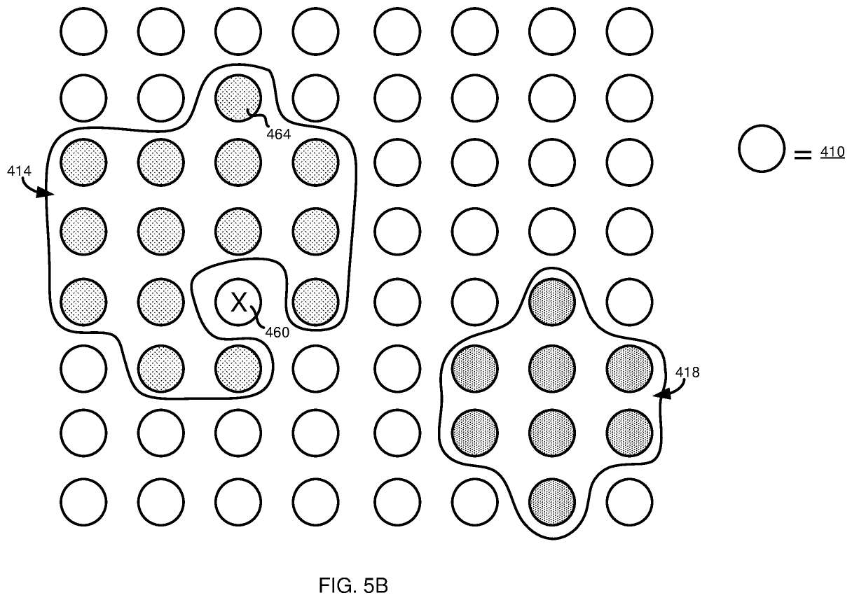

FIGS. 5A and 5B illustrate how a configuration of a neural network can be modified in view of a computing element that has failed or is otherwise unreachable. The scenario is based on the collection of computing elements 410 of FIG. 4A, including the definitions of the first and second neural networks 414, 418.

In FIG. 5A, it is determined that a computing element 460 of the first neural network 414 is unreachable. The collection of computing elements 410 is analyzed, such as by a command-and-control computing system 322 as described in Example 6, to determine another computing element that can take the place of the computing element 460 in the first neural network 414. Assume that a computing element 464 is identified as a replacement for the computing element 460.

The definition of the first neural network 414 is updated to remove the computing element 460 and add the computing element 464. The resulting structure of the neural network 414 is shown in FIG. 5B.

Note that the reconfiguration typically only affects the devices that serve as particular nodes of the neural network, not the structure of the neural network itself (its internal topology). For example, reconfiguration typically would not change the number of layers, the number of nodes in a layer, or the connections between nodes. Rather, reconfiguration restores the internal topology by replacing failed nodes with active nodes.

### Example 9—Example Information Maintainable for Distributed Neural Networks

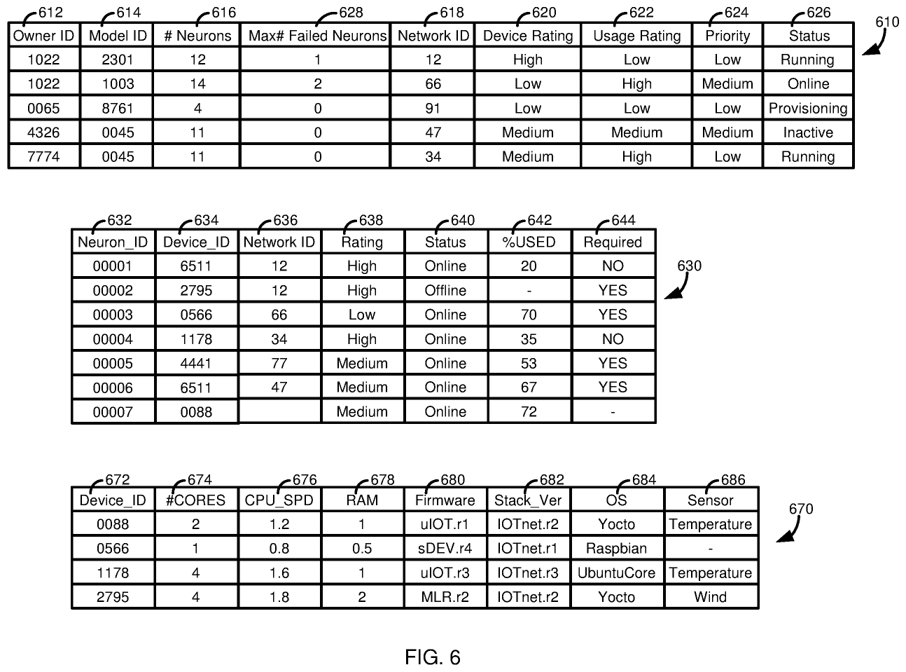

FIG. 6 illustrates examples of data that can be maintained to facilitate the creation and maintenance of distributed neural networks, as well as the processing of data requests that use such distributed neural networks. The data is shown as being maintained in the form of tables 610, 630, 670. In some implementations, the tables 610, 630, 670 are implemented in a relational database system. However, the data shown in the tables 610, 630, 670 can be maintained in any suitable manner, and need not be in the form of tables. In addition, it should be appreciated that less, more, or different information can be included than that illustrated in FIG. 6. Data for the tables 610, 630, 670 at least in some cases is described with respect to an implementation using IOT devices, but it should be appreciated that analogous information can be included for other types of computing elements.

The table 610 represents data that reflects an assignment of a particular neural network definition to a particular collection of computing elements that implement the neural network. The details of the neural network definition, such as the connections between neurons, weights, and activation functions, can be maintained elsewhere, as can the details of the computing elements in the network. The table 610 represents an example of information that can be maintained by the model manager 342 of the command-and-control computing system 322 of FIG. 3.

The table 610 includes a column 612 that associates a particular model with a particular owner (in the form of an owner ID maintained in the column), where the owner can be a particular client (such as the client 326 of FIG. 3), or a particular user. The owner ID can be used, among other things, to authenticate requests to use a particular neural network, including to access computing elements that implement the neural network, as well as to authenticate requests to modify or configure a distributed neural network according to the present disclosure. A column 614 includes a model ID, where the model ID can be linked to other tables (or other data sources) that provide further information about a model identified by a particular model ID value. For example, the model ID can be linked to a table that includes a model definition, such as can be maintained in the model repository 338. As described in conjunction with the model repository 338, a model definition can define nodes, node types, connections between nodes, weights to be applied to node inputs, and an activation function to be used by a particular node, as well as configuration information that can be used to help control how a distributed neural network is deployed/configured.

A column 616 of the table 610 lists a number of neurons included in the network, which can be useful, for example, when starting to provision a network. A column 618 of the table provides a network ID for a particular record of the table 610, where the network ID can be used to retrieve information about a particular implementation of a distributed neural network that implements a model identified by the model ID of the column 614. The network ID can link to information that defines, for example, what computing elements are assigned to a particular network, as well as assigning particular computing elements to particular neurons of a particular model.

The table 610, or another table that can be accessed using information of the table 610 (such as a network ID or a model ID) includes information that can be used when an instance of a model is to be created in a collection of computing elements. For example, a column 620 of the table 610 indicates a “quality” of computing elements that at least is preferred for use in a particular neural network for a particular model. Similarly, a column 622 of the table 610 provides an indication of a level of request activity that is expected for the neural network, and a column 624 identifies a priority associated with a particular model and implementing network for a particular owner, where the priority can be used, among other things, to schedule data processing requests or to assign higher-priority networks to more performant or more available computing elements.

A column 626 of the table can provide a status for a particular combination of model, network, and owner. The status can have various values, including whether the network is currently executing a task, is online and available for executing tasks (but is not currently executing a task), is in a state of being provisioned (in which case it is typically not yet available for task execution), or is inactive (where an inactive model/network/owner combination can indicate, for instance, that a network is unavailable due to issues with its constituent computing elements, or that the network is unavailable for other reasons, such as because it is a lower priority network and network computing elements are “busy,” or because an owner of the network/model has chosen to temporarily disable the network for use with the model, but prefers to maintain the definitional/configuration information, such as if the user desires to later reactivate the network/model combination).

As mentioned earlier, a particular neural network can be associated with a maximum number of failed neurons, or can specify neurons that are required, or not required (where a neural network can continue to operate if a non-required neuron fails, but not if a required neuron fails). Table 610 includes a column 628 that indicates a maximum number of failed neurons for a particular neural network.

Table 630 provides information for individual computing elements of a collection of computing elements that can be used to implement distributed neural networks. The table 630 can represent information that is used by the device registry 330 (or in some cases, the job manager 334) of the command-and-control computing system 322 of FIG. 3. The table 630 includes a column 632 that provides a neuron ID. In some cases, a neuron ID can be unique, and thus can be used to identify a particular neuron of a particular model. In other cases, neuron IDs need not be unique, and unique identification of neurons can be achieved by using a neuron ID in combination other information, such as a model ID (not shown as an attribute in the table 630, which could be included if desired).

A column 634 of the table 630 identifies a particular computing element that implements a particular neuron, while a column 636 identifies a particular network in which the neuron/device are used. Since the records of the table 630 correspond to specific computing elements, columns of the table 630 can provide information for particular computing elements. In particular, a column 638 of the table 630 provides a rating (such as indicating a quality) of a particular computing element, while a column 640 provides status information for the computing element and a column 642 provides information about the use of a computing element, such as providing an indication of available/used computing resources.

The information in the columns 640 and 642 can be used, among other things to determine whether a network should be reconfigured to remove/replace an unreachable computing element, or to replace an overloaded computing element with a computing element having more available processing resources. Similarly, the information in the column 642 can be used in determining which computing elements to assign as nodes in particular neural networks, such as to preferably assign less used computing elements to neural networks rather than increasing the load on a computing element that has a substantially higher load than other computing elements. A column 644 indicates whether a particular neuron is required for a particular network.

The table 670 includes additional information about particular computing elements, and can represent information maintained by the device registry 330 of FIG. 3. The information in the table 670 can be used in assigning computing elements to serve as particular neurons, including by applying rules to the information where the rules are used to classify the computing element (such as having high, medium, or low processing capabilities). Column 672 provides a device identifier for a particular computing element, while columns 674-678 provide information about computing resources of the computing element (number of processing cores, processor speed, and amount of memory). In some cases, particularly where a computing element is an IOT device, and the IOT device provides input to a neural network, it can be useful to maintain additional information about the IOT device, such as a firmware version used by the IOT device (column 680) and information about sensors (column 686) included in the IOT device (as shown, if a device includes multiple sensors, the IOT device can be represented by multiple entries in the table 670). That is, while in some cases external values are supplied to computing elements to be processed, in other cases a computing element can both provide at least a portion of inference data to be used in a data processing request and perform the operations of one or more neurons in a neural network used for the data processing request.

Other information can affect how a particular computing element can be used, including an operating system used in the computing element or a version of a node operational stack that is installed on the computing element, where these values can be indicated in columns 682, 684, respectively.

### Example 10—Example Techniques for Creating a Distributed Neural Network and Neuronal Operations of Computing Elements

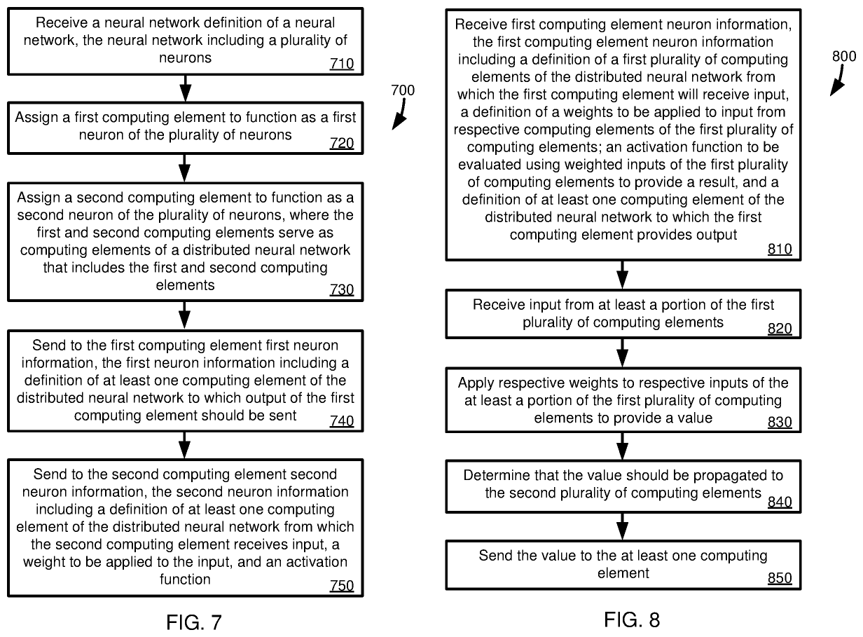

FIG. 7 is a flowchart of a method 700 for creating a distributed neural network comprising a plurality of computing elements. The method 700 can be implemented using IOT devices or types of computing elements as described in conjunction with the neural network 200 of FIG. 2 or the computing environment of FIG. 3, and in particular can represent operations performed by the command-and-control computing system 322 of FIG. 3.

At 710, a neural network definition is received of a neural network. The neural network includes a plurality of neurons. A first computing element is assigned to function as a first neuron of the plurality of neurons at 720. At 730, a second computing element is assigned to function as a second neuron of the plurality of neurons.

First neuron information is sent to the first computing element at 740. The first neuron information includes a definition of at least one neuron of the neural network to which output of the first neuron should be sent. At 750, second neuron information is sent to the second computing element. The second neuron information includes a definition of at least one neuron of the neural network from which the second neuron receives input, a weight to be applied to the input, and an activation function.

FIG. 8 is a flowchart of a method 800 for processing a portion of a data processing request to a distributed neural network by a computing element that implements at least one neuron of the distributed neural network along with a plurality of other computing elements that implement other neurons of the distributed neural network. The method 800 can be implemented using IOT devices or other types of computing elements as described in conjunction with the neural network 200 of FIG. 2 or the computing environment of FIG. 3.

At 810, first computing element neuron information is received. The first computing element neuron information includes a definition of a first plurality of computing elements of the distributed neural network from which the first computing element will receive input, a definition of a weights to be applied to input from respective computing elements of the first plurality of computing elements; an activation function to be evaluated using weighted inputs of the first plurality of computing elements to provide a result, and a definition of at least one computing element of the distributed neural network to which the first computing element provides output.

Input from at least a portion of the first plurality of computing elements is received at 820. At 830, respective weights are applied to respective inputs of the at least a portion of the first plurality of computing elements to provide a value. It is determined at 840 that the value should be propagated to the second plurality of computing elements. The value is sent to the at least one computing element at 850.

### Example 11—Computing Systems

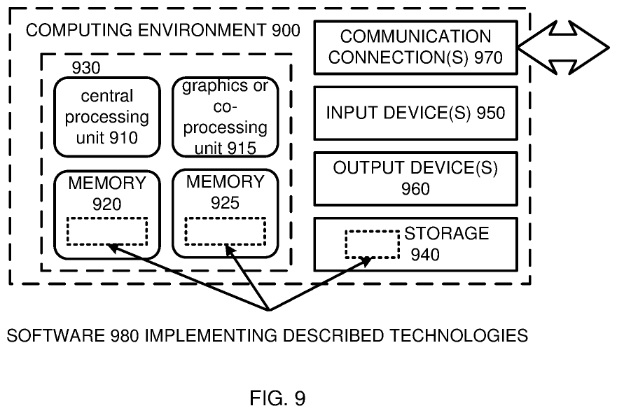

FIG. 9 depicts a generalized example of a suitable computing system 900 in which the described innovations may be implemented. The computing system 900 is not intended to suggest any limitation as to scope of use or functionality of the present disclosure, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions, such as for implementing a data archival environment, and associated methods, such as described Examples 1-10. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s) 910, 915. The memory 920, 925 stores software 980 implementing one or more innovations described herein, in the form of computer-executable instructions suitable for execution by the processing unit(s) 910, 915.

A computing system 900 may have additional features. For example, the computing system 900 includes storage 940, one or more input devices 950, one or more output devices 960, and one or more communication connections 970, including input devices, output devices, and communication connections for interacting with a user. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information in a non-transitory way and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. The output device(s) 960 may be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 12—Cloud Computing Environment

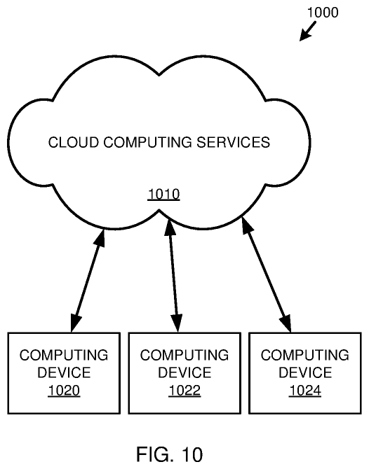

FIG. 10 depicts an example cloud computing environment 1000 in which the described technologies can be implemented. The cloud computing environment 1000 comprises cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries).

The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operations (e.g., data processing, data storage, and the like).

### Example 13—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 9, computer-readable storage media include memory 920 and 925, and storage 940. The term computer-readable storage media does not include signals and carrier waves. In addition, the term computer-readable storage media does not include communication connections (e.g., 970).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network, or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
at least one hardware processor;
at least one memory coupled to the at least one hardware processor; and
one or more computer-readable storage media storing computer-executable instructions that, when executed, cause the computing system to perform operations comprising:
receiving a neural network definition of a neural network, the neural network definition comprising a plurality of neurons;
assigning a first computing element to function as a first neuron of the plurality of neurons;
assigning a second computing element to function as a second neuron of the plurality of neurons, wherein the second computing element is different than, but is directly or indirectly in communication, with the first computing element, and the first neuron is different than the second neuron, and wherein the first and second computing elements serve as computing elements of a distributed neural network that comprises the first and second computing elements;
sending to the first computing element first neuron information, the first neuron information comprising a definition of at least one computing element of the distributed neural network to which output of the first computing element should be sent; and
sending to the second computing element second neuron information, the second neuron information comprising a definition of at least one computing element of the distributed neural network from which the second computing element receives input, a weight to be applied to the input, and an activation function.

2. The computing system of claim 1, wherein the first computing element is a first Internet of things (IOT) device.

3. The computing system of claim 2, wherein the first Internet of things device comprises at least one hardware sensor.

4. The computing system of claim 3, the operations further comprising:
sending a data processing request to the distributed neural network, the distributed neural network comprising at least one measurement recorded by the at least one hardware sensor or data derived as least in part from the at least one measurement.

5. The computing system of claim 2, wherein computing elements of the distributed neural network consist of IOT devices.

6. The computing system of claim 1, the operations further comprising:
determining that the second computing element is not available;
assigning a third computing element to function as the second neuron, wherein the third computing element is different than the first computing element and the second computing element, but is directly or indirectly in communication with the first computing element; and
sending the second neuron information to the third computing element.

7. The computing system of claim 1, the operations further comprising:
determining that a computing element serving as at least one neuron of the distributed neural network is not available to process data processing requests;
determining from configuration information for the distributed neural network that data processing is permitted despite the at least one neuron of the distributed neural network being unavailable; and
submitting a data processing request to the distributed neural network while the at least one neuron is unavailable.

8. The computing system of claim 7, wherein the determining from configuration for the distributed neural network that data processing is permitted despite the at least one neuron of the distributed neural network being unavailable, and the submitting the data processing request are performed by a client computing system.

9. The computing system of claim 1, wherein each node of the distributed neural network is implemented on a different computing element of a plurality of computing elements that implement the distributed neural network, wherein the plurality of computing elements comprises the first computing element and the second computing element.

10. The computing system of claim 1, the operations further comprising:
assigning a third computing element to function as the second neuron, wherein the third computing element is different than the first computing element and the second computing element, but is directly or indirectly in communication with the first computing element; and
sending the second neuron information to the third computing element, wherein a given data processing request for the distributed neural network uses only the second computing element or the third computing element to function as the second neuron.

11. A method, implemented in a computing system serving as a first computing element of a distributed neural network and comprising at least one hardware processor and at least one memory coupled to the at least one hardware process, the method comprising:
receiving first computing element neuron information, the first computing element neuron information comprising a definition of a first plurality of computing elements of the distributed neural network from which the first computing element will receive input, a definition of a weights to be applied to input from respective computing elements of the first plurality of computing elements; an activation function to be evaluated using weighted inputs of the first plurality of computing elements to provide a result, and a definition of at least one computing element of the distributed neural network to which the first computing element provides output;
receiving input from at least a portion of the first plurality of computing elements;
applying respective weights to respective inputs of the at least a portion of the first plurality of computing elements to provide a value;
evaluating the value using the activation function;
determining that the value should be propagated to a second plurality of computing elements; and
sending the value to the at least one computing element.

12. The method of claim 11, wherein the first computing element is an Internet of things (IOT) computing device comprising at least a first hardware sensor, the method further comprising:
receiving input from the at least a first hardware sensor; and
sending the input from the at least a first hardware sensor, or a value derived at least in part therefrom, to a computing device, wherein the computing device is not part of the distributed neural network and neither the input or the value are sent from the IOT device to a computing element of the distributed neural network.

13. The method of claim 11, wherein the first computing element is an Internet of things (IOT) computing device comprising at least a first hardware sensor, the method further comprising:
receiving input from the at least a first hardware sensor; and
using the input, or a value derived at least in part therefrom, in a data processing request to be processed using the distributed neural network.

14. One or more computer-readable storage media comprising:
computer-executable instructions that, when executed by a computing system comprising at least one hardware processor and at least one memory coupled to the at least one hardware processor, cause the computing system to receive a neural network definition of a neural network, the neural network definition comprising a plurality of neurons;
computer-executable instructions that, when executed by the computing system, cause the computing system to assign a first computing element to function as a first neuron of the plurality of neurons;
computer-executable instructions that, when executed by the computing system, cause the computing system to assign a second computing element to function as a second neuron of the plurality of neurons, wherein the second computing element is different than, but is directly or indirectly in communication with, the first computing element, and the first neuron is different than the second neuron, and wherein the first and second computing elements serve as computing elements of a distributed neural network that comprises the first and second computing elements;
computer-executable instructions that, when executed by the computing system, cause the computing system to send to the first computing element first neuron information, the first neuron information comprising a definition of at least one computing element of the distributed neural network to which output of the first computing element should be sent; and
computer-executable instructions that, when executed by the computing system, cause the computing system to send to the second computing element second neuron information, the second neuron information comprising a definition of at least one computing element of the distributed neural network from which the second computing element receives input, a weight to be applied to the input, and an activation function.

15. The one or more computer-readable storage media of claim 14, wherein the first computing element is a first Internet of things (IOT) device.

16. The one or more computer-readable storage media of claim 15, wherein the first Internet of things device comprises at least one hardware sensor.

17. The one or more computer-readable storage media of claim 16, further comprising:
computer-executable instructions that, when executed by the computing system, cause the computing system to send a data processing request to the distributed neural network, the distributed neural network comprising at least one measurement recorded by the at least one hardware sensor or data derived as least in part from the at least one measurement.

18. The one or more computer-readable storage media of claim 14, further comprising:
computer-executable instructions that, when executed by the computing system, cause the computing system to determine that the second computing element is not available;
computer-executable instructions that, when executed by the computing system, cause the computing system to assign a third computing element to function as the second neuron, wherein the third computing element is different than the first computing element and the second computing element, but is directly or indirectly in communication with the first computing element; and
computer-executable instructions that, when executed by the computing system, cause the computing system to send the second neuron information to the third computing element.

19. The one or more computer-readable storage media of claim 14, further comprising:
computer-executable instructions that, when executed by the computing system, cause the computing system to determine that a computing element serving as at least one neuron of the distributed neural network is not available to process data processing requests;
computer-executable instructions that, when executed by the computing system, cause the computing system to determine from configuration information for the distributed neural network that data processing is permitted despite the at least one neuron of the distributed neural network being unavailable; and
computer-executable instructions that, when executed by the computing system, cause the computing system to submit a data processing request to the distributed neural network while the at least one neuron is unavailable.

20. The one or more computer-readable storage media of claim 14, wherein each node of the distributed neural network is implemented on a different computing element of a plurality of computing elements that implement the distributed neural network, wherein the plurality of computing elements comprises the first computing element and the second computing element.
